(19) United States
(12) Patent Application Publication
(10) Pub. No.: US 2005/0193867 A1
(43) Pub. Date: Sep. 8, 2005

(54) Tool for facilitating removal of container closing devices

(76) Inventor: Phillip K. Haynes, New Martinsville, WV (US)

Correspondence Address: PRICE & ADAMS, P.C., 4135 BROWNSVILLE ROAD, P.O. BOX 98127, PITTSBURGH, PA, 15227-0127, US

(21) Appl. No.: 11/065,665

(22) Filed: Feb. 24, 2005

Related U.S. Application Data
(60) Provisional application No. 60/547,286, filed on Feb. 25, 2004.

(51) Int. Cl. B67B 7/14

(52) U.S. Cl. 81/3.4

(57) ABSTRACT

A tubular ring includes an inner surface for receiving a bottle cap. A top portion extends from one side of the ring to provide an elongated outer surface and a bottom portion extends from the opposite side of the ring to define an opening for receiving the cap. The cap is inserted into the opening and the ring expands to accommodate the cap. The inner surface frictionally engages the bottle cap, so that the cap is rotated relative to a bottle to remove the cap from the bottle.

### BACKGROUND OF THE INVENTION

1. Field of the Invention

This invention relates to a tool for facilitating removal of container closing devices, and more particularly, to an improved apparatus and method for removing caps, lids, and tops that shield the drinking areas of a container.

2. Description of the Related Art

Many tools or openers have been developed or adapted to assist in the opening of jars, lids, caps, and other devices for closing containers. Most openers on the market are either flat or cone shaped rubber materials or hard plastic. Existing openers may be hard mounted or handheld. Existing containers do not provide for maintenance of clean surfaces at the top portion of closed containers that are adjacent to the container closing device.

Many existing openers are tubular devices that facilitate the removal of a container closure device, such as a jar, lid, or cap. U.S. Pat. No. Des. 395,810 discloses an ornamental design for a cap removal device. U.S. Pat. No. 6,640,665 discloses a flexible tubular cap removal device having an enclosed top and an open end portion. U.S. Pat. No. 4,856,025 discloses a tubular radiator cap removal device having an enclosed top and an open end bottom portion.

U.S. Pat. No. 3,919,901 discloses a flexible tool for facilitating removal of screw-cap bottle closures. The tool includes an essentially cylindrical resilient body having an enclosed top and an open end bottom portion. The open end bottom portion forms a socket having a substantially wedge-shaped sealing lip to prevent leakage from the bottle. The resilient body is rigidified by a rigid ring, preferably constructed from steel wire. The body also includes a protuberance that provides additional grip to facilitate removal of the screw-cap bottle closures.

U.S. Pat. No. 4,702,129 discloses an essentially spherical tubular gripper fabricated of rubber-like resilient material for facilitating the removal of a cap. The gripper includes a round body having an enclosed top and an open end bottom portion. The open end bottom portion includes a crater or saucer-like recess formed in the body. The bottom portion may also define an additional conical or cylindrical recess extending from the crater. The elasticity of the material provides gripping and leverage on small container caps.

U.S. Pat. No. Des. 293,819 discloses an ornamental design for a frustoconical shaped test tube remover. The test tube remover includes an essentially cylindrical top portion having a flat upper surface, a frustoconical transition portion extending from the top portion, and a shallow bottom portion. The bottom portion has an essentially cylindrical shape that defines a lip extending from the transition portion.

U.S. Pat. No. 4,001,904 discloses a conical kitchen utensil for opening jar caps. The utensil includes a generally conical tubular body with an enclosed top and an open end bottom portion and a stepped hollow interior portion for gripping a cap to turn the cap. The body is made from a rubber or plastic material that has a naturally high coefficient of friction to cause secure engagement of a jar cap.

U.S. Pat. No. 3,604,290 discloses a conical device for releasing closure members from containers. The device includes a generally conical tubular body with an enclosed top and an open end bottom portion. The body includes a recess that includes a gripping member that is made from a resilient elastic material, such as natural or synthetic rubber.

U.S. Pat. No. 4,766,781 discloses a device for removing caps or jar lids that includes two tubular conical members, a hard outer pressure cone and a generally conical inner elastomeric insert. The elastomeric material of the insert is stretched and distorted by a lid when the opener presses down upon a jar with a tight lid after being introduced into the opener, as shown at numeral. This action creates an improved grip by enveloping the rim of the lid to a greater extent than when the insert is flat against the lid surface.

While it is known to make generally cylindrical, tubular cap or lid removal devices for opening containers, such devices do not protect the upper portion of such containers from dirt, sweat, or other contaminants. Accordingly, there is a need for an improved apparatus and method for removing caps, lids, and tops that shields the drinking areas of a container.

### SUMMARY OF THE INVENTION

In accordance with the present invention there is provided a container-opening device having an annular tubular ring with an opening for receiving a cap and an inner surface for frictionally engaging the cap. An annular tubular flexible top portion extends from one side of the ring defining an inner surface and an elongated outer surface extending outwardly from the ring so that the top portion overlies the cap when the ring receives the cap. An annular tubular bottom portion extends from the opposite side of the ring defining an inner surface having a greater inner diameter than the top portion inner surface and an outer surface that extends below the cap when the ring receives the cap. The top portion has a smaller outer diameter than the bottom portion so that the top portion outer surface facilitates the manual manipulation of the container-opening device. The top portion inner surface, the bottom portion inner surface, and the ring inner surface form a continuous surface for adhering to the cap to facilitate removal of the cap from a container.

Further in accordance with the present invention, there is provided a bottle cap removal apparatus having a flexible annular tubular body with a narrow upper section, a wide lower section, and a tapered transition section connecting the upper section to the lower section. The upper section has an elongated outer surface for gripping and squeezing the bottle cap removal apparatus. The body defines a continuous cavity with an inner surface extending from the lower section to the upper section that expands to frictionally engage the cap to facilitate removal of the cap from a bottle. The lower section defines an opening communicating with the continuous cavity to receive a closed bottle cap and a top portion of a bottle so that the upper section overlies the bottle cap and the lower section shields the bottle top portion.

Further in accordance with the present invention, there is provided a method for removing a container closing device from a closed container that includes the steps of providing a flexible body having an elongated outer surface, an annular skirt extending therefrom, and an internal cavity defining an oversized mouth for receiving a closed container and a tapered inner surface for receiving the container closing device. The body outer surface is gripped to manipulate the body and position the body over the closed container with the container closing device and the oversized mouth in an overlying relationship. The closed container is inserted into the oversized mouth so that the annular skirt overlies the container closing device and an upper portion of the closed container. The container covering device is frictionally engaged with the body inner surface. The body is rotated relative to the container to remove the container closing device from the container.

Accordingly, a principal object of the present invention is provide an improved apparatus and method for removing caps, lids, and tops that shields the drinking areas of a container.

Another object of the present invention is to provide a container opening apparatus that includes a flexible cylindrical portion that has an outer surface for facilitating the manual manipulation, gripping, and squeezing of the apparatus.

A further object of the present invention is to provide a flexible tubular cap opener that expands to accommodate a cap and frictionally engages the cap to facilitate removal of the cap from a container.

A further object of the present invention is to provide an improved cap opening device and shield that frictionally engages container caps for removal through rotation.

Another object of the present invention is to provide a cap, lid, or top removal device that is manufactured from a non-slip material.

A further object of the present invention is to provide a cap, lid, or top removal device that prevents contamination of the drinking area of a container by dirt, sweat, or other unsanitary substances.

These and other objects of the present invention will be more completely described and disclosed in the following specification, accompanying drawings, and appended claims.

### BRIEF DESCRIPTION OF THE DRAWINGS

FIG. 1 is an isometric view of one embodiment of a tool for facilitating the removal of caps, lids, tops, and other container closing devices.

FIG. 2 is a top plan view of the tool shown in FIG. 1.

FIG. 3 is a cross sectional view in side elevation taken along line II-II of FIG. 2.

FIG. 4 is a view in side elevation of the tool shown in FIG. 1, illustrating the tool positioned on a screw-top water bottle.

FIG. 5 is a fragmentary sectional view of the tool shown in FIG. 1, illustrating the tool surrounding a screw-top cap of a water bottle.

FIG. 6 is a cross section view in side elevation of the tool illustrating the tool positioned over a push-and-twist medication bottle.

FIG. 7 is an isometric view of another embodiment of a tool for facilitating the removal of caps, lids, tops, and other container closing devices.

FIG. 8 is a view of the tool shown in FIG. 7, illustrating the tool positioned in surrounding relationship with a screw-top cap of a water bottle.

FIG. 9 is a fragmentary sectional view of the tool shown in FIG. 7, illustrating the tool positioned on a screw-top cap of a water bottle.

FIG. 10 is an isometric view from one end of the tool shown in FIG. 7, illustrating the tool in a folded position.

FIG. 11 is an isometric view from the opposite end of the tool shown in FIG. 10 in a folded position.

FIG. 12 is a view in side elevation of a plurality of folded container opening tools shown in FIGS. 10 and 11, illustrating the folded tools stacked on a display device.

### DESCRIPTION OF THE PREFERRED EMBODIMENTS

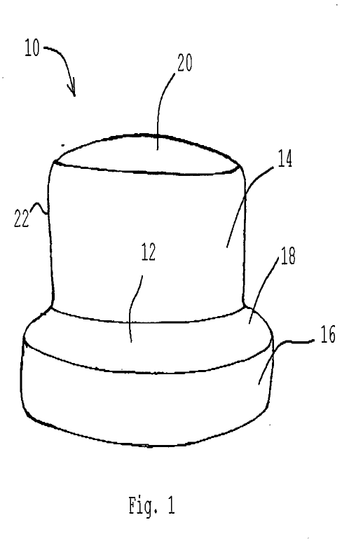

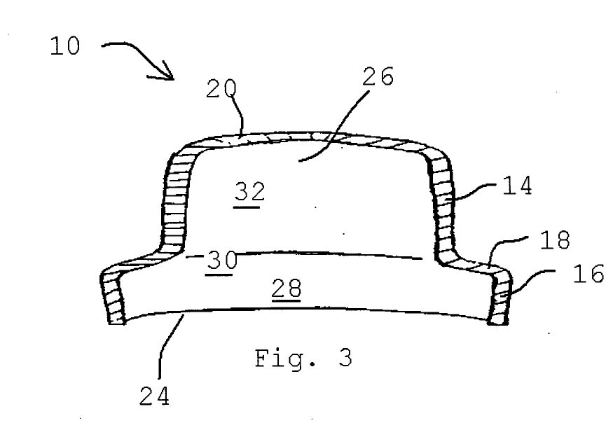

Referring to the drawings and, particularly, to FIGS. 1 and 3, there is shown a tool generally designated by the numeral 10, for facilitating the removal of caps, lids, tops, and other container closing devices. The tool 10 includes a tubular body 12 having a narrow upper section 14, a wide lower section 16, a tapered transition section 18, and a top or lid 20. The transition section 18 connects the upper section 14 to the lower section 16.

The body 12 is an essentially annular, integral ring with the upper section 14 defining a top portion and the lower section 16 defining a bottom portion. The upper section 14 includes an elongated outer surface 22 extending outwardly from the ring to facilitate manipulation of the body 12. The surface area provided by the elongated outer surface 22 is particularly useful for manual manipulations, such as gripping or squeezing, that facilitate placement and removal of the body 12 onto various containers.

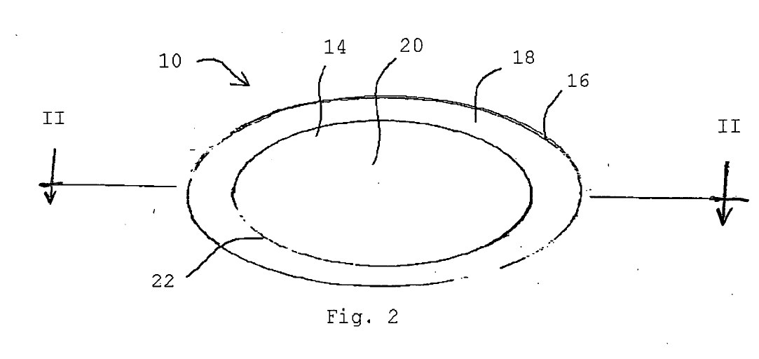

As shown in FIGS. 2 and 3, the body 12 includes an opening 24 and a continuous cavity 26 that communicates with the opening 24. The cavity 26 extends into the lower section 16 to define a lower chamber or mouth 28. The cavity 26 also includes a transition chamber 30, which is defined by the transition section 18, and an upper chamber 32, which is defined by the upper section 14.

As shown in FIG. 3, the body 12 has an essentially constant wall thickness from the lower section 16 to the upper section 14. The inner diameter of the lower section 16 is substantially greater than the inner diameter of the upper section 14, so that the lower chamber 28 has a substantially greater width than the upper chamber 32. The inner diameter of the transition section 18 is tapered.

As shown in FIG. 3, the geometric shape of the body 12 is generally cylindrical with the upper section 14 and lower section 16 being cylindrical. The transition section 18 is essentially frustoconical and the top 20 is essentially conical. The body shape of the lower section 16 is not critical and may be constructed to include other shapes, such as cubes, rhombohedrons, hexagonals, or other geometries.

The body 12 is made from any suitable material, preferably from a flexible synthetic or natural plastic material such as an elastomeric material by a conventional manufacturing process. The term plastic material includes all thermoplastic materials, as well as all thermosets, rubbers, and other network polymers. The term elastomeric material includes any polymeric or plastic material, natural or synthetic, that exhibits the properties of an elastomer or plastomer, including rubbers, thermoplastic elastomers, blends, or alloys thereof. The body 12 has a sufficiently high coefficient of friction to allow an inner surface to frictionally engage lids, caps, and tops that are made from various materials, such as plastics, metals, ceramics, and composites. Preferably, the body 12 is made from a flexible PVC material through a conventional manufacturing process.

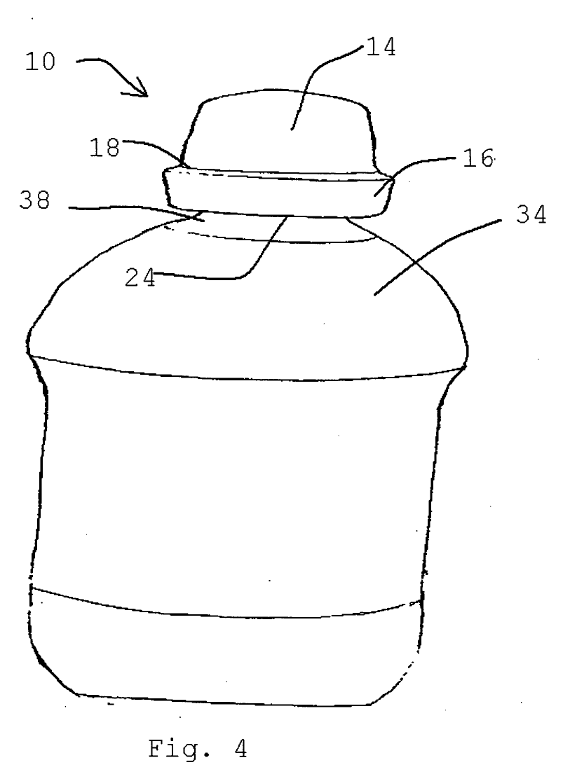

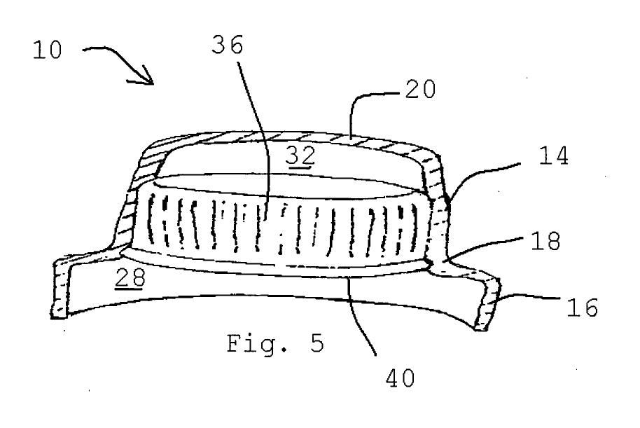

Referring now to FIGS. 4 and 5, the tool 10 is used with conventional screw-top bottles 34, such as plastic drinking water bottles and soda bottles. The tool 10 is positioned in overlying relation with a bottle 34 with a cap 36 inserted through the opening 24, so that the body 12 forms a shield around the cap 36. The tool 10 is positioned in the overlying relation for storage or display prior to or after being used to facilitate removal of the cap 36 from the bottle 34. Preferably, the lower section 16 covers a top portion 38 of the bottle 34, which is adjacent to a drinking area 40, so that the lower section 16 forms a protective skirt or shield to protect the drinking area 40 from dirt, sweat, or other non-hygienic or undesirable substances.

As shown in FIG. 5, the dimensions of the tool 10 are preselected to accommodate most standard sized bottles and containers. The cap 36 is positioned within the inner cavity 26 after insertion with the body upper section 14 extending above the cap 36. The inner surface 42 of the body 12 frictionally engages the cap 36 to facilitate removal of the cap 36 from the bottle 34. The body 12 is sufficiently flexible to expand when the cap 36 is inserted into the opening 24 to allow the cavity 26 to accommodate the cap 36. The inner diameter of the inner surface 42 is less than the outer diameter of the cap 36, so that the upper section 14 extends above the cap 36 after insertion.

The geometry of the cavity 26 is also preselected to accommodate most standard sized bottles. The lower chamber 28 and the upper chamber 32 are essentially conical. The transition chamber 30 is essentially frustoconical. In the preferred embodiment, the cavity geometry is essentially the same as the geometry of the bottle outer surface.

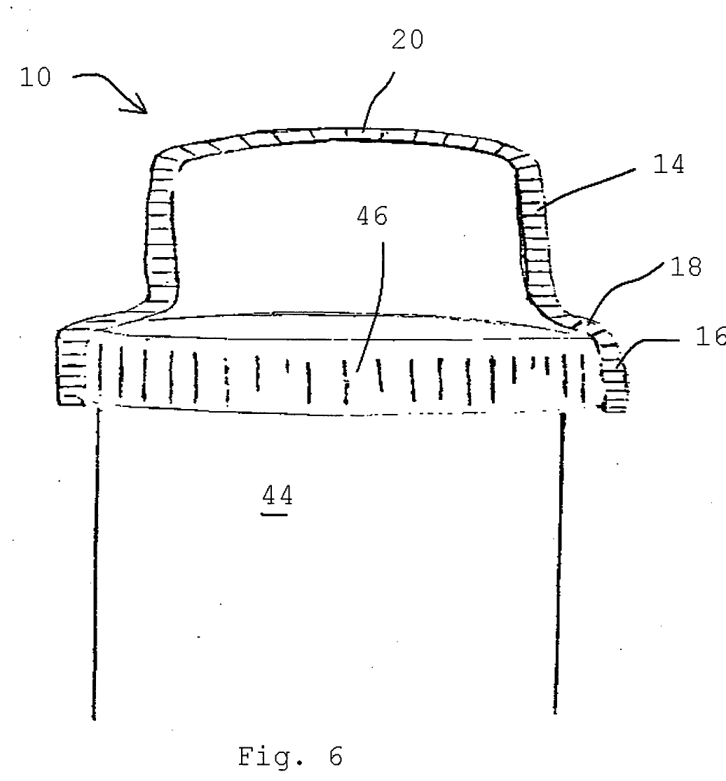

As shown in FIG. 6, the tool 10 is also used with push-and-twist type medication bottles 44 and lids 46, which is especially useful to facilitate removal of the lids 46 by elderly or arthritic users. The bottle 44 and lid 46 are inserted through the opening 24 into the inner cavity 26 in the same manner as the bottle 34 and cap 36 shown in FIGS. 4-5, so that the lid 46 is positioned within the inner cavity 26 after insertion. The position of the lid 46 within the inner cavity 26 relative to the body top 20 depends upon the lid outer diameter with larger diameter lids 46 being positioned further away from the body top 20.

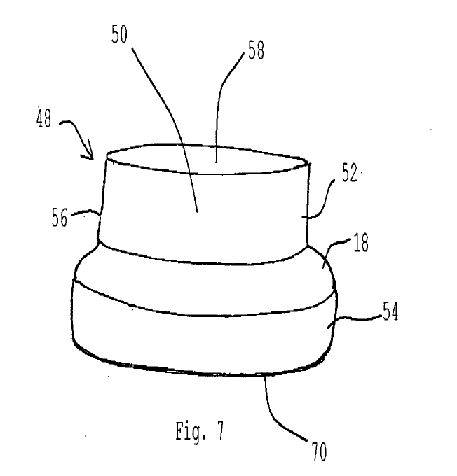

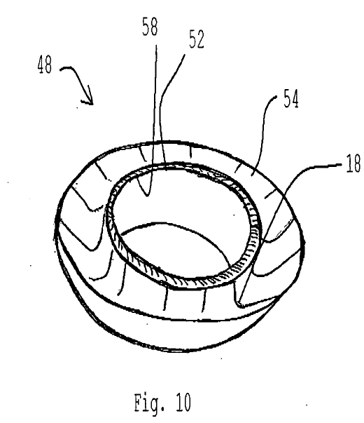

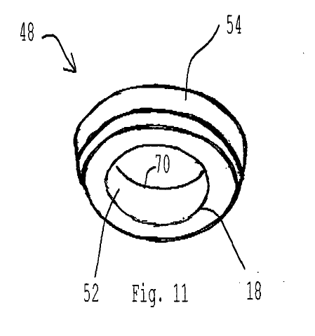

Referring now to FIGS. 7-12, there is illustrated a second embodiment of the tool 10 shown in FIGS. 1-6 in which like elements are identified by like numerals shown in FIGS. 1-6. The second embodiment is generally designated by the numeral 48. The tool 48 includes a flexible tubular body 50 having a narrow upper section 52, a wide lower section 54, and a tapered transition section 18 connecting the upper section 52 to the lower section 54. The upper section 52 includes an extended outer surface 56 having sufficient surface area to facilitate manual manipulation of the tool 48.

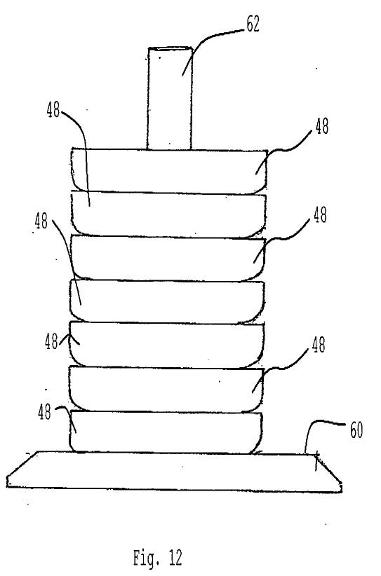

Unlike the embodiment shown in FIGS. 1-6, the upper section 52 includes an opening 58 to facilitate storage of the tool 48 on a display rack 60, as shown in FIG. 12. The display rack 60 includes an elongated member or rod 62, which is inserted through the opening 58 to allow a plurality of tools 48 to be stacked for display or storage. The opening 58 also facilitates separation of caps 36 from the tool 48 after the caps 36 have been inserted therein.

As shown in FIGS. 7-9, the upper section 52, the lower section 54, and the transition section 18 define a continuous inner cavity 64 that extends throughout the body 48. The cavity 64 communicates with the opening 58 and includes a lower chamber or mouth 66, a transition chamber 32, and an upper chamber 68. The lower section 54 shown in FIG. 7 also includes an opening 70 that communicates with the cavity 64. The opening 58 communicates with the opening 70 through the continuous inner cavity 64, so that the body 50 resembles a sleeve.

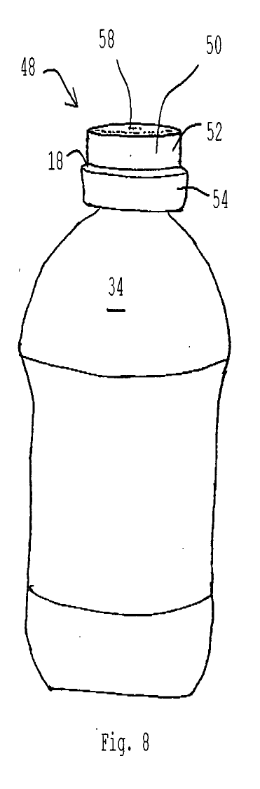

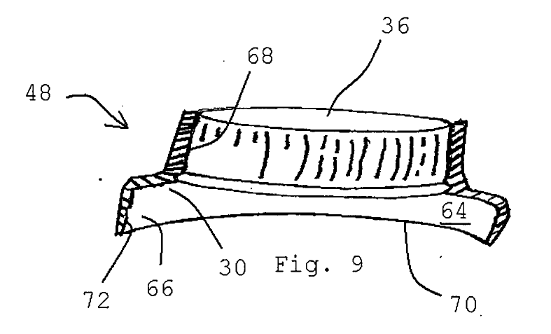

As shown in FIGS. 8 and 9, the tool 48 is positioned in overlying relation with a bottle 34 and cap 36 in a similar manner as the tool 10 shown in FIGS. 4-5. In operation, the body 48 is provided in an initial position, so that the outer surface 56 facilitates positioning of the body 48 onto the bottle 34 and cap 36. The outer surface 56 is gripped to manipulate the body 48 into the overlying relationship with the bottle 34 and cap 36. The cap 36 is inserted into the oversized mouth 30, so that the lower section 54 covers the cap 36 and the top portion 38 of the bottle 34 forming a shield or skirt for protecting the drinking area 40.

As shown in FIG. 9, the body 48 stretches after insertion to accommodate the cap 36 where the body 48 is flush with the top of the cap 36. The stretching of the body 48 causes the internal cavity 64 to frictionally engage the cap 36 to facilitate removal of the cap 36 from the bottle 34. The position of the cap 36 within the cavity 64 depends upon the outer diameter 38, so that the upper section 52, the lower section 54, the transition section 18, or a combination thereof will expand to accommodate the cap 36. Preferably, the dimensions of the body 48 are preselected to position most standard sized caps 36 within the transition section 18. Alternatively, the upper section 52, the lower section 54, and the transition section 18 have sufficient flexibility to accommodate most standard sized caps 36.

After the cap 36 is inserted into the body 48 and the body 48 frictionally engages the cap 36, the body 48 is gripped for rotation. Simultaneously, the bottle 34 is gripped for counter rotation or to remain in a fixed position. The body 48 is rotated relative to the bottle 34 to separate the cap 36 from the bottle 34 facilitating removal thereof. Preferably, the dimensions of the outer surface 56 are preselected to provide sufficient mechanical advantage to facilitate removal of the cap 36 from the bottle 34.

Referring now to FIGS. 9-12, the body 50 has sufficient flexibility to allow the upper section 52 to be folded over the lower section 54 to facilitate storage of the tool 48 on the display rack 60, shown in FIG. 12. The inner edge 72 of the lower section 54 has a tapered cross section as shown in FIG. 9 so that the diameter of the mouth 66 gradually increases in the direction from the transition section 18 to the opening 70. The tapered wall thickness facilitates the folding operation.

In operation, the body 50 is displayed, as shown in FIG. 12, on the display rack 60 in a folded position or an unfolded position. The body 50 is moved from the unfolded position to the folded position by rotating the lower section 54 about the transition section 18 in a rolled-up manner. In the folded position, the lower section 54 is in overlying relation with the upper section 52. The display rack rod 62 is inserted through the opening 58 to place the tool 48 on the display rack 60 and additional tools are inserted thereon.

It should be understood that alternative tools are contemplated in accordance with the present invention and include tools having interior surface features that facilitate frictional engagement with caps, lids, tops, and other container closing devices, and more particularly, tools having an interior surface with ribs, ridges, or other similar means for enhancing frictional engagement.

According to the provisions of the patent statutes, I have explained the principle, preferred construction and mode of operation of my invention and have illustrated and described what I now consider to represent its best embodiments. However, it should be understood that, within the scope of the appended claims, the invention may be practiced otherwise than as specifically illustrated and described.

1. A container opening device comprising:
an annular tubular ring having an opening for receiving a cap and an inner surface for frictionally engaging the cap,
an annular tubular flexible top portion extending from one side of said ring defining an inner surface and an elongated outer surface extending outwardly from said ring so that said top portion overlies the cap when said ring receives the cap,
an annular tubular bottom portion extending from the opposite side of said ring defining an inner surface having a greater inner diameter than the top portion inner surface and an outer surface that extends below the cap when said ring receives the cap,
said top portion having a smaller outer diameter than said bottom portion so that said top portion outer surface facilitates the manual manipulation of the container opening device, and
said top portion inner surface, said bottom portion inner surface, and said ring inner surface forming a continuous surface for adhering to the cap to facilitate removal of the cap from a container.

2. A container opening device as set forth in claim 1 in which:
said top portion includes an essentially conical lid positioned adjacent to said top portion outer surface to form a closed top for said annular ring.

3. A container opening device as set forth in claim 1 which includes:
said top portion having an opening so that said inner surface defines a cylindrical inner surface and said top portion opening communicates with said bottom portion opening to allow the insertion of a member into the annular ring to facilitate stacking of the cap opening device on a display rack.

4. A container opening device as set forth in claim 3 which includes:
said annular ring being sufficiently flexible to fold said bottom portion over the top portion to facilitate stacking of the cap opening device on a display rack.

5. A container opening device as set forth in claim 1 in which:
said annular ring includes a flexible elastomeric material.

6. A container opening device as set forth in claim 1 which includes:
said top portion being a flexible cylinder, and
said bottom portion being a flexible cylinder.

7. A container opening device as set forth in claim 6 which includes:
a flexible cylindrical transition portion connecting said top portion to said bottom portion and having the ability to expand into surrounding gripping relation with the cap.

8. A bottle cap removal apparatus comprising:
a flexible annular tubular body having a narrow upper section, a wide lower section, and a tapered transition section connecting said upper section to said lower section,
said upper section having an elongated outer surface for gripping and squeezing the bottle cap removal apparatus,
said body defining a continuous cavity with an inner surface extending from said lower section to said upper section that expands to frictionally engage the cap to facilitate removal of the cap from a bottle, and
said lower section defining an opening communicating with said continuous cavity to receive a closed bottle cap and a top portion of a bottle so that said upper section overlies the bottle cap and said lower section shields the bottle top portion.

9. A bottle cap removal apparatus as set forth in claim 8 in which:
said body includes a conical lid positioned adjacent to said upper section to form a closed top.

10. A bottle cap removal apparatus as set forth in claim 8 which includes:
said upper section having an opening so that said continuous cavity allows the insertion of a member into said body to facilitating stacking of the cap opening device on a display rack.

11. A bottle cap removal apparatus as set forth in claim 10 which includes:
said body defining a cylinder.

12. A bottle cap removal apparatus as set forth in claim 10 which includes:
said lower section having the ability to fold over the upper section to facilitate stacking of said body on a display rack.

13. A bottle cap removal apparatus as set forth in claim 8 in which:
said body includes an elastomeric material.

14. A bottle cap removal apparatus as set forth in claim 8 which includes:
said upper section being a flexible cylinder, and
said lower section being a flexible cylinder.

15. A method for removing a container closing device from a closed container comprising the steps of:
providing a flexible body having an elongated outer surface, an annular skirt extending therefrom, and an internal cavity defining an oversized mouth for receiving a closed container and a tapered inner surface for receiving the container closing device,
gripping the body outer surface to manipulate the body and position the body over the closed container with the container closing device and the oversized mouth in an overlying relationship,
inserting the closed container into the oversized mouth so that the annular skirt overlies the container closing device and an upper portion of the closed container,
frictionally engaging the container covering device with the body inner surface, and
rotating the body relative to the container to remove the container closing device from the container.

16. A method as set forth in claim 15 which includes:
covering the container closing device with the skirt to shield the container closing device and a top portion of the container.

17. A method as set forth in claim 15 which includes:
providing the flexible body in a folded position with the annular skirt folded over the elongated outer surface, and
unfolding the annular skirt to facilitate the gripping step.

18. A method as set forth in claim 17 which includes:
stacking the flexible body on a display rack.

19. A method as set forth in claim 17 which includes:
stacking the flexible body in the folded position on a display rack.

20. A method as set forth in claim 15 which includes:
stretching the flexible body to expand the inner surface to accommodate the container closing device.
